(19) United States
(12) Patent Application Publication
(10) Pub. No.: US 2011/0185503 A1
(43) Pub. Date: Aug. 4, 2011

(54) Local Adjustment Device for Radiotherapy

(75) Inventor: Di Yan, Auburn Hills, MI (US)

(73) Assignee: William Beaumont Hospital, Royal Oak, MI (US)

(21) Appl. No.: 12/696,595

(22) Filed: Jan. 29, 2010

(51) Int. Cl. A61G 7/065; A61G 7/00

(52) U.S. Cl. 5/601

(57) ABSTRACT

A cradle for supporting an anatomical portion of a patient during radiotherapy includes a plurality of air chambers and at least one pressure regulator that adjusts the pressure in each air chamber. The cradle may be connected to an electronic control unit that sends instructions to the at least one pressure regulator to pressure each air chamber to a desired pressure.

### BACKGROUND

This invention relates to a local adjustment device for radiotherapy. Presently, online treatment dose construction and estimation include portal ex-dose reconstruction to reconstruct treatment dose on a conventional linear accelerator. Specifically, the exit dose is measured using an MV portal imager to estimate treatment dose in the patient. However, this method has not been employed for patient treatment dose construction, since the dose reconstruction method lacks patient anatomic information during the treatment, and the scattered exit dose is difficult to calibrate properly.

In the past, a single pre-treatment computed tomography scan has been used to design a patient treatment plan for radiotherapy. Use of such a single pre-treatment scan can lead to a large planning target margin and uncertainty in normal tissue dose due to patient variations, such as organ movement, shrinkage and deformation, that can occur from the start of a treatment session to the end of the treatment session. Furthermore, present procedures for head and neck radiotherapy require the molding of a cradle to position the patient's head. The patient wears a mask which clamps the head in position against the formed cradle. Also, the forming of a mold dedicated to each particular patient is costly and requires a significant amount of time. Moreover, changes in the patient anatomy can occur during the course of treatment, making recasting sometimes necessary.

### BRIEF SUMMARY

In overcoming the limitations of the related art, the present invention provides a cradle for supporting an anatomical portion of a patient during radiotherapy. The cradle includes a plurality of air chambers and at least one pressure regulator that adjusts the pressure in each air chamber. The cradle may be connected to an electronic control unit that sends instructions to the at least one pressure regulator to pressure each air chamber to a desired pressure.

Further features and advantages of this invention will become readily apparent from the following description and from the claims.

### BRIEF DESCRIPTION OF THE DRAWINGS

In the accompanying drawings the components are not necessarily to scale, emphasis instead being placed upon illustrating the principles of the invention. Moreover, like reference numerals designate corresponding parts throughout the views. In the drawings:

FIG. 1 schematically shows an embodiment of a radiation therapy system that employs a dose tracking and feedback process and a possible workflow for auto-construction, estimation and evaluation of cumulative treatment dose, and patient anatomy and dose feedback for adaptive planning optimization in accordance with the present invention;

FIGS. 2a-2e shows an embodiment of an onboard imaging system and/or radiation therapy systems to be used with the radiation therapy system of FIG. 1 for performing dose tracking and feedback in accordance with the invention;

FIG. 3 is a perspective view of a cradle for immobilizing a patient's head in accordance with the invention;

FIG. 4 is a top view of the cradle in accordance with the invention;

FIG. 5 is a side view of the cradle in accordance with the invention; and

FIG. 6 is a perspective view of another embodiment of a cradle for immobilizing a patient's head in accordance with the invention.

### DETAILED DESCRIPTION

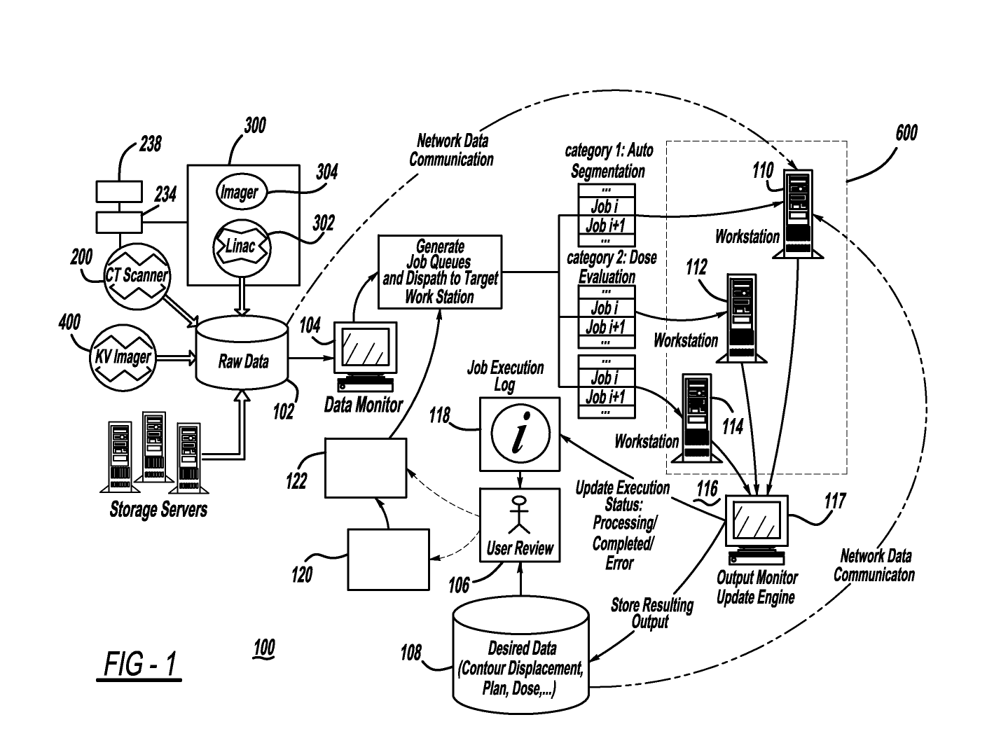

Referring now to FIG. 1, generally illustrated therein is a schematic view of a volumetric image guided adaptive radiotherapy system, such as cone-beam computerized tomography (CBCT) image guided adaptive radiotherapy (IGART) system 100, and a corresponding workflow sequence for auto-construction and evaluation of daily cumulative treatment dose is also shown in FIG. 1, wherein like elements are denoted by like numerals. As shown in FIG. 1, the CBCT IGART system 100 includes a number of major systems: 1) a three-dimensional volumetric imaging system, such as an x-ray cone-beam computed tomography system 200, 2) a megavoltage (MeV)imaging system 300 that includes a radiation therapy source, such as a linear accelerator 302, and an imager 304, 3) a kilovoltage (kV)_portal imager processor/software system 400 and 4) a treatment dose tracking and feedback system 600, each of which are discussed below.

Mechanical operation of a cone-beam computed tomography system 200 is similar to that of a conventional computed tomography system, with the exception that an entire volumetric image is acquired through less than two rotations (preferably one rotation) of the source and detector. This is made possible by the use of a two-dimensional (2-D) detector, as opposed to the one-dimensional (1-D) detectors used in conventional computed tomography.

An example of a known cone-beam computed tomography imaging system is described in U.S. Pat. No. 6,842,502, the entire contents of which are incorporated herein by reference. The patent describes an embodiment of a cone-beam computed tomography imaging system that includes a kilovoltage x-ray tube and a flat panel imager having an array of amorphous silicon detectors. As a patient lies upon a treatment table, the x-ray tube and flat panel image rotate about the patient in unison so as to take a plurality of images as described previously.

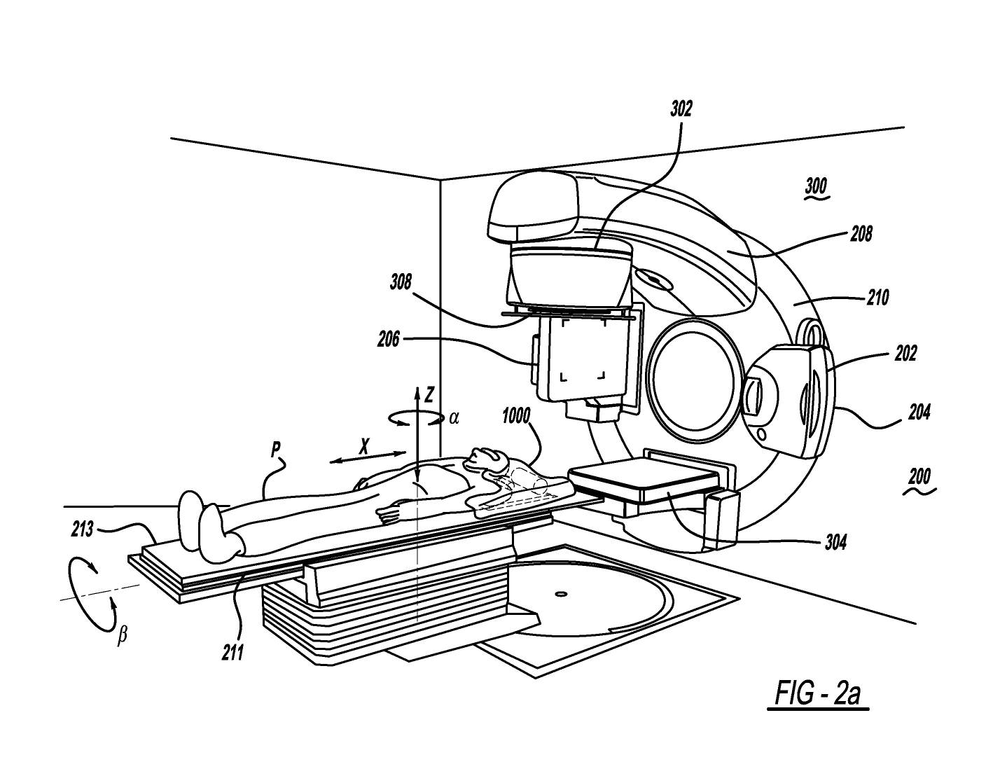

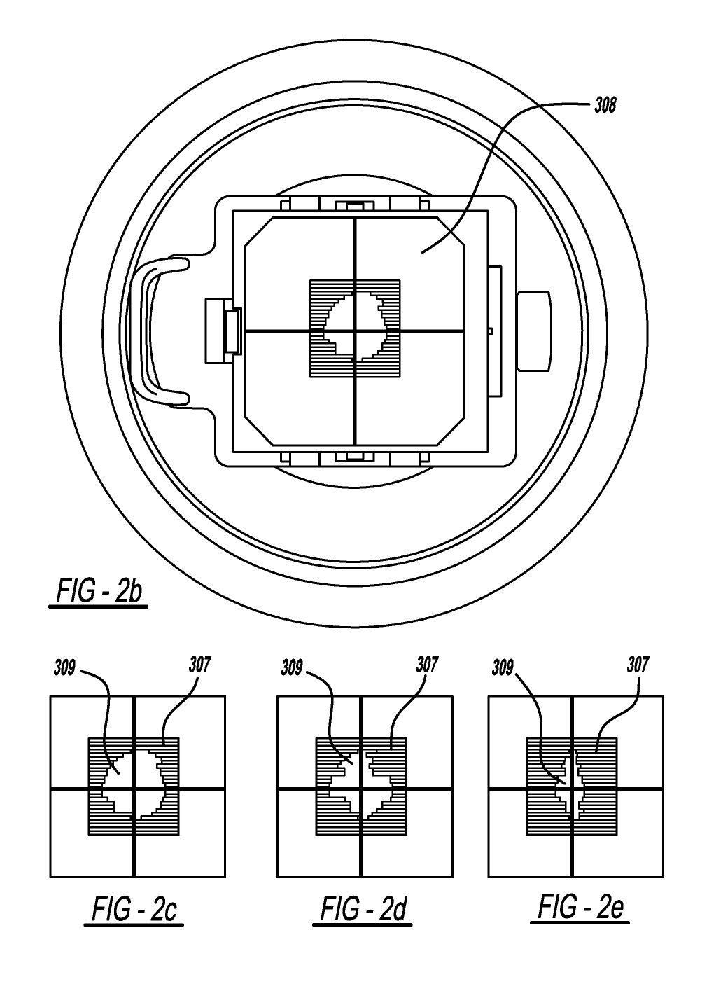

As shown in FIG. 2a, a volumetric imaging systems is illustrated. In particular, FIG. 2a shows an embodiment of a wall-mounted cone-beam computed tomography system 200 and MeV portal imaging system 300 that can be adapted to be used with the cone-beam computed tomography and megavoltage portal imaging system sold under the trade name Synergy by Elekta of Crawley, the United Kingdom. Such systems 200 and 300 are described in pending U.S. patent application Ser. No. 11/786,781, entitled “Scanning Slot Cone-Beam Computed Tomography and Scanning Focus Spot Cone-Beam Computed Tomography” and filed on Apr. 12, 2007, the entire contents of which are incorporated herein by reference.

The cone-beam computed tomography system 200 includes an x-ray source, such as x-ray tube 202, a rotary collimator 204 and a flat-panel imager/detector 206 mounted on a gantry 208. As shown in FIG. 2a, the flat-panel imager 206 can be mounted to the face of a flat, circular, rotatable drum 210 of the gantry 208 of a medical linear accelerator 302, where the x-ray beam produced by the x-ray tube 202 is approximately orthogonal to the treatment beam produced by the radiation therapy source 302.

Note that the detector 206 can be composed of a two-dimensional array of semiconductor sensors that may be each made of amorphous silicon (a-Si:H) and thin-film transistors. The analog signal from each sensor is integrated and digitized. The digital values are transferred to the data storage server 102.

After the fan beams from collimator 204 traverse the width of a patient P and impinge on the entire detector 206 in the manner described above, computer 234 instructs the drum 210 to rotate causing the x-ray source 202, the collimator 204 and the detector 206 rotate about the patient P to another position so that the scanning process described above can be repeated and another two-dimensional projection is generated. The above rotation of the x-ray source 202, collimator 204 and detector 206 is continued until a sufficient number of two-dimensional images are acquired for forming a cone-beam computed tomography image. Less than two rotations should be needed for this purpose (images formed from a rotation of less than 360° can be formed as well). The two-dimensional projections from each position are combined in the computer 234 to generate a three-dimensional image to be shown on display 236 in a manner similar to that of the cone-beam computed tomography systems described previously.

As shown in FIG. 2a, the system 300 includes a separate radiation therapy x-ray source, such as a linear source 302 and a detector/imager 304 that are separately mounted to the rotating drum 210. The source 302 operates at a power level higher than that of x-ray tube 202 so as to allow for treatment of a target volume in a patient lying on a movable table 211 (movable in x, y and z-direction via computer 234). The linear source 302 generates a beam of x-rays or particles, such as photons, protons or electrons, which have an energy ranging from about 4 MeV to about 25 MeV.

As mentioned above, the particles are used to treat a specific area of interest of a patient, such as a tumor. Prior to arriving at the area of interest, the beam of particles is shaped by adjusting multiple leafs 307 (FIGS. 2b-e) to have a particular cross-sectional area 309 via a multi-leaf collimator 308. The cross-sectional area 309 is chosen so that the beam of particles interacts with the area of interest to be treated and not areas of the patient that are healthy. The radiation penetrating through the area of interest can be imaged via imager 304 in a well known manner.

As shown in FIG. 1, the treatment dose tracking and feedback system 600 includes a workstation or data server 110 that includes processors dedicated to perform a segmentation/registration process on a three-dimensional, volumetric image of a patient received from server 102 that was generated by cone-beam computed tomography system 200. The workstation 110 is able to identify and register each volume of image data within each volumetric image. Such identification and registration allows for the same volume of image data to be tracked in position from one therapy session to another therapy session.

The treatment dose tracking and feedback system 600 further includes a workstation or data server 112 that includes processors dedicated to perform a treatment dose construction process based on 1) the segmentation/registration process performed by workstation 110 and 2) parameters of the beam of radiation emitted from the source 302 as it impinges on the patient that are measured and stored in server 102, such as angular position, beam energy and cross-sectional shape of the beam, in accordance with a reference plan. Such parameters can be in the form of the angular position of the gantry 208, the angular orientation of the collimator 308, the positions of the leaves of the multi-leaf collimator 308, position of the table 211 and energy of the radiation beam. Once the position and shape of a subvolume of image data is known, the treatment dosage received by that very same subvolume can be determined/constructed based on the above mentioned parameters of the beam of radiation emitted from the source 302 as it impinges on the patient. Such a determination is made for each of the subvolumes of image data for each of the volumetric images generated by system 200.

The treatment dose tracking and feedback system 600 further includes a workstation or data server 114 that includes processors dedicated to perform a an adaptive planning process that can either 1) adjust the radiation therapy treatment for the particular day in a real-time manner based on off-line and on-line information or 2) adjust a radiation therapy treatment plan in a non-real-time manner based on off-line information. The adjustment is based on how the dose calculated by the workstation 112 differs from dose preferred by the treatment plan. Note that the term “real-time” refers to the time period when the radiation therapy source is activated and treating the patient. The term “on-line” regards when a patient is on the treatment table and “off-line” refers to when the patient is off the treatment table.

In summary, the treatment dose tracking and feedback system 600 can perform real time treatment dose construction and 4D adaptive planning based on volumetric image information and therapy beam parameters that are measured in a real time manner during a therapy session. The system 600 can also perform adaptive planning in a non-real-time manner as well. Such real time and non-real time processes will be discussed in more detail with respect to the process schematically shown in FIG. 6. Note that in an alternative embodiment, the workstations 110, 112 and 114 can be combined into a single workstation wherein the processes associated with workstations 110, 112 and 114 are performed by one or more processors. Note that the real time treatment dose construction determined by workstation 112 and the 4D adaptive planning determined by workstation 114 can be displayed on a monitor 117 of Quality Assurance (QA) evaluation station 116. Based on the information displayed on monitor 117, medical personnel can alter, if required, the calculated 4D adaptive plan so as to be within acceptable parameters. Thus, the QA evaluation station 116 acts as a way to ensure confidence in future real time changes made to the therapy session. In this scenario, the QA evaluation station 116 and the treatment dose tracking and feedback system 600 can be collectively thought of as a 4D planning and control system.

With the above description of the onboard cone-beam computed tomography system 200, megavoltage imaging and radiation therapy system 300, QA evaluation station 116 and the treatment dose tracking and feedback system 600 in mind, the operation of the CBCT IGART system 100 of FIG. 1 can be understood. In particular, the previously described online volumetric imaging information and real time therapy beam parameters are captured from systems 200, 300 and 400 and stored in data storage server 108. The volumetric imaging information and therapy beam parameters are then sent to data monitor job controller 104 that automatically assigns tasks, based on pre-designed treatment schedule and protocol, to each of the work stations 110, 112 and 114 and controls the accomplishment of such tasks. The tasks are stored in temporal job queues 124 for dispatching, based on clinical priorities, to each of the workstations 110, 112 and 114. The clinical priority can be reassigned from a clinical user's request 122 based on the treatment review and evaluation on the physician evaluation/decision making station 106. In addition, the station 106 also provides commands for treatment/plan modification decisions. The modification server 120 receives commands from the station 106 and modifies the ongoing treatment plan, beam or patient position on the system 300 based on the optimized adaptive plan created from the adaptive planning workstation 114.

As shown in FIG. 1, the raw data from server 108 is also sent to a workstation 110. The workstation 110 is dedicated to perform an autosegmentation/registration process on a three-dimensional, volumetric image of a patient generated by cone-beam computed tomography system 200. The raw data from server 108 is also sent to workstation 112 and workstation 114. Workstation 112 performs daily and cumulative treatment dose construction/evaluation from the raw data. Workstation 114 performs adaptive planning from the raw data. These three workstations 110, 112 and 114 perform their tasks automatically with order of their job queues 126, 128 and 130, respectively. The above described segmentation/registration, treatment dose construction/evaluation and adaptive planning will be described later with respect to the process schematically shown in FIG. 6.

As shown in FIG. 1, the segmentation/registration, treatment dose construction and adaptive planning information generated from workstations 110, 112 and 114 is sent to the QA evaluation station 116 which interacts with a clinical user to verify and modify, if necessary, the results from the above workstations 110, 112 and 114. The output from QA evaluation station 116 is then stored in derived data server 108.

The QA station 116 provides an update execution status to job execution log server 118 that supplies information whether processing of information is presently occurring, whether processing is completed or whether an error has occurred. Whenever a task of treatment dose construction or adaptive planning modification is completed by workstations 112 and 114, respectively, the evaluation station 116 provides treatment evaluation information which includes both the current treatment status and the completed treatment dose and outcome parameters estimated based on the patient and treatment data from previous treatments. The user at QA evaluation station 116 can then provide commands or a new clinical schedule to the high priority job request server 122 to either request new information or modify clinical treatment schedule. In addition, the user can also make decisions to execute a new adaptive plan or perform a treatment/patient position correction through the server 120.

The CBCT IGART system 100 performs a number of processes, including a kV portal imaging process via kV portal imaging processor/software and a an image guided adapted radiation therapy process 500, among other processes. Further details of the system 100 can be found in U.S. application Ser. No. 12/556,270, filed Sep. 9, 2009, the entire contents of which is incorporated herein by reference.

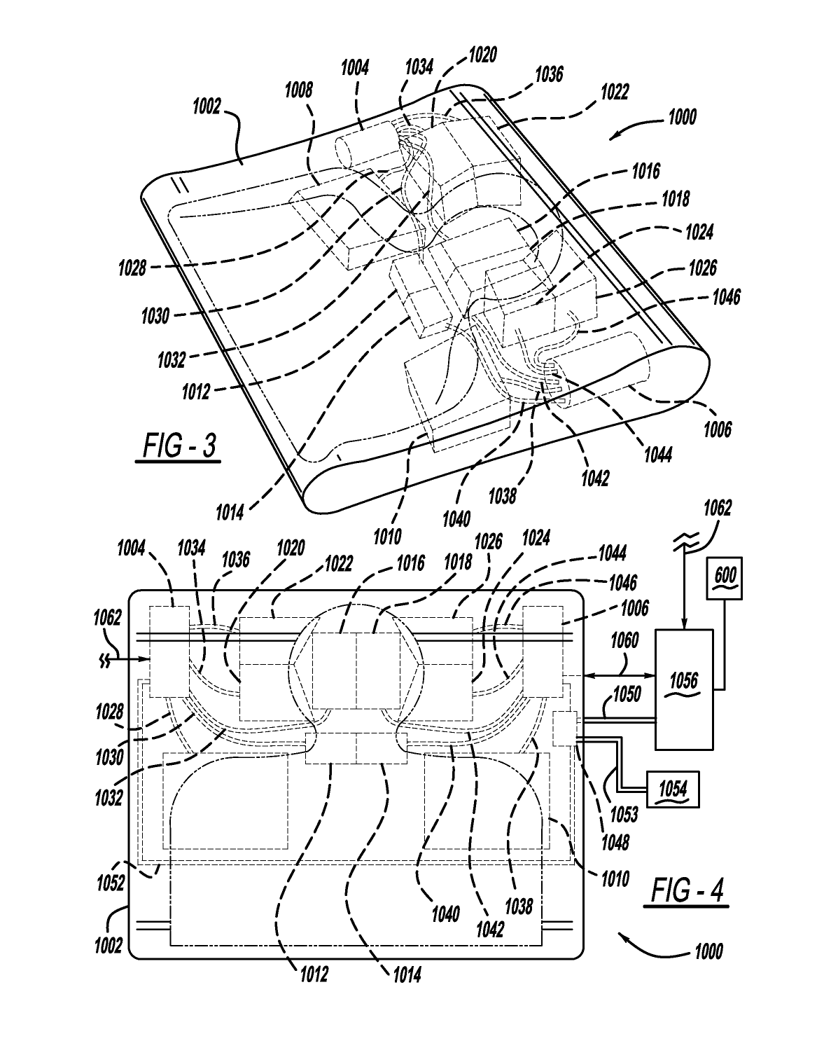

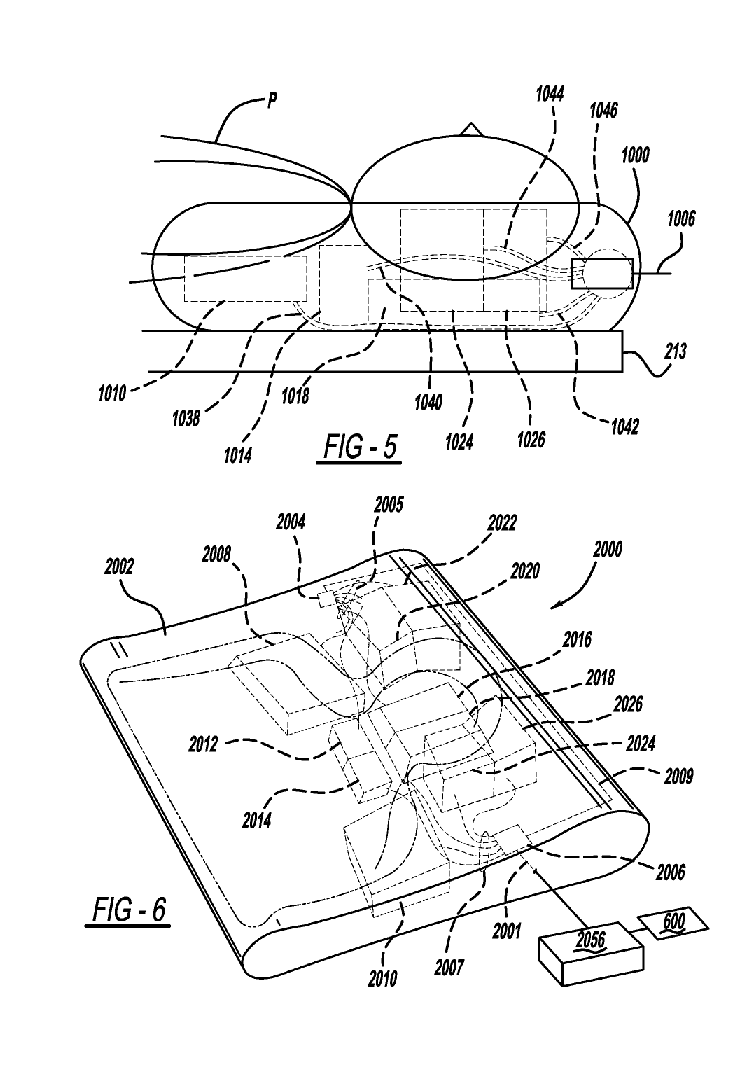

Referring to FIGS. 3 through 5, there is shown a particular implementation of local adjustment device or cradle 1000 that positions and immobilizes the head of a patient P who is supported on a table top 213 during radiotherapy. The cradle 1000 includes a cover 1002 enclosing a pair of pressure regulators 1004 and 1006. As illustrated, the cradle 1000 includes ten air chambers or cells 1008, 1010, 1012, 1014, 1016, 1018, 1020, 1022, 1024, and 1026 made of a suitable flexible material or membrane.

The air chambers 1008, 1012, 1016, 1020, and 1022 are connected to the pressure regulator 1004 with flexible conduits or tubing 1028, 1030, 1032, 1034, and 1036, respectively, and the air chambers 1010, 1014, 1018, 1024, and 1026 are connected to the pressure regulator 1006 with tubing 1038, 1040, 1042, 1044, and 1046, so that each air chamber can be pressurized through its respective tubing to a desired pressure.

The air chambers 1008 and 1010 primarily provide support to the patient's shoulder regions; the air chambers 1012 and 1014 provide support mostly to the patient's neck region; the air chambers 1016 and 1018 provide support to the back of the patient's head; and the air chambers 1020, 1022, 1024, and 1026 provide lateral support to either side of the patient's head.

The cradle 1000 also includes a valve 1048 connected to the pressure regulators 1004 and 1006 with tubing 1050 and 1052, respectively. The valve is connected in turn to a gas supply 1054 with a tubing 1053. The gas supply typically provides air to the air chamber via the valve 1048 and the pressure regulators 1004 and 1006, but can provide any other suitable gas in various implementations.

The pressure regulators 1004 and 1006 and the valve 1048 receive signals and provide feedback to an electronic control unit (ECU) 1056. As shown, the pressure regulators 1004 and 1006 are connected to the ECU 1056 with electrical connections or lines 1062 and 1060, and the valve 1048 is connected to the ECU 1056 with a connection or line 1058. In other implementations, the communication between the ECU 1056 and the valve 1048 and the pressure regulators 1004 and 1006 can occur through a wireless system. The ECU 1056 may receive instructions directly from an operator and/or the ECU 1056 may be connected to a control system such as, for example, the treatment dose tracking and feedback system 600 of the IGART system 100.

When the cradle 1000 is in use, the air chambers 1008, 1010, 1012, 1014, 1016, 1018, 1020, 1022, 1024, and 1026 cradle the patient's head as each of the air chambers is inflated individually. The ECU 1056 sends instructions to the pressure regulators 1004 and 1006 to adjust the pressure in the various air chambers 1008, 1010, 1012, 1014, 1016, 1018, 1020, 1022, 1024, and 1026 to provide immobilization and/or positioning of the patient's head. The cradle 1000 can be employed to immobilize other body parts or anatomical portions, as well, during treatment. The cradle 1000 can also allows for movement of the patient P during treatment.

Turning now to FIG. 6, another cradle embodying the principles of the present invention is illustrated therein and designated at 2000. As its primary components the cradle 2000 includes a flexible cover 2002 and a set of 10 air chambers 2008, 2010, 2012, 2014, 2016, 2018, 2020, 2022, 2024, and 2026. Each of which is made of a suitable flexible material or membrane.

The air chambers 2008 and 2010 primarily provide support to the patient's shoulder regions; the air chambers 2012 and 2014 provide support mostly to the patient's neck region; the air chambers 2016 and 2018 provide support to the back of the patient's head; and the air chambers 2020, 2022, 2024, and 2026 provide lateral support to either side of the patient's head.

Also enclosed in the cover 2002 is a pair of microprocessors 2004 and 2006. The microprocessor 2006 is connected to an ECU 2056 with an electrical connection 2001 and to the other microprocessor 2004 with an electrical connection 2009. In some implementations the microprocessor 2004 is connected directly to the ECU 2056.

Each of the air chambers 2008, 2010, 2012, 2014, 2016, 2018, 2020, 2022, 2024, and 2026 operates as an individual electrically controlled pressure regulator or pump. Accordingly, the air chambers communicate with the microprocessors 2004 and 2006 through a set of electrical connections 2005 and a set of electrical connections 2007, respectively. In particular, each of the air chambers 2008, 2012, 2016, 2020, and 2022 receives individual signals from the microprocessor 2004 through a respective electrical connection of the set of electrical connections 2005, and each of the air chambers 2010, 2014, 2018, 2024, and 2026 receives individual signals from the microprocessor 2006 through a respective electrical connection of the set of electrical connections 2007.

The microprocessors 2004 and 2006 receive signals and provide feedback to the electronic control unit (ECU) 2056. In certain implementations, the communication between the ECU 2056 and the microprocessors 2004 and 2006 is wireless. In yet other implementations, the ECU 2056 communicates directly with the air chambers 2008, 2010, 2012, 2014, 2016, 2018, 2020, 2022, 2024, and 2026 through a set of electrical connections or through a wireless system. The ECU 2056 may receive instructions directly from an operator and/or the ECU 2056 may be connected to a control system such as, for example, the treatment dose tracking and feedback system 600 of the IGART system 100.

When the cradle 2000 is in use, the air chambers 2008, 2010, 2012, 2014, 2016, 2018, 2020, 2022, 2024, and 2026 cradle the patient's head as each of the air chambers inflates individually. The ECU 2056 sends instructions to the microprocessors 2004 and 2006 to adjust the pressure in the various air chambers 2008, 2010, 2012, 2014, 2016, 2018, 2020, 2022, 2024, and 2026 to provide immobilization and/or positioning of the patient's head. The cradle 2000 can be employed to immobilize other body parts or anatomical portions, as well, during treatment of the patient. The cradle 2000 also allows for movement of the patient during treatment, for example, when the patient changes position.

Although the cradles 1000 and 2000 are shown with ten air chambers, other implementations of the cradles 1000 and 2000 may use fewer chambers or more than ten chambers. The registration of the patient can take place through the use of a digital camera which therefore does not involve any dose exposure. The various components of the cradles 1000 and 2000 are typically made of materials that do not attenuate x-ray. Software can be implemented in the ECUs 1056 and 2056 to adjust pressure in the various air chambers as needed to position and reposition the patient.

In proton therapy systems, a fixed beam is typically formed with a large accelerator, and therefore the beam is difficult to reposition between therapy sessions or during a particular therapy session. Further, certain anatomical features of a patient are difficult to treat using a proton beam on a convention table or couch. Various implementations of the cradles 1000 and 2000 are suitable for use in such proton therapy systems and, further, can be adapted for a sitting patient on a chair-type system.

Other embodiments are within the following claims.

What is claimed is:

1. A cradle for supporting an anatomical portion of a patient during radiotherapy comprising:
a plurality of air chambers, each air chamber being individually pressurized; and
at least one pressure regulator that adjusts the pressure in each air chamber.

2. The cradle of claim 1 wherein each air chamber is made of a flexible material.

3. The cradle of claim 1 further comprising a cover, the plurality of air chambers and the at least one pressure regulator being enclosed within the cover.

4. The cradle of claim 1 wherein each of the plurality of air chambers is connected to the at least one pressure regulator with a flexible tube.

5. The cradle of claim 1 further comprising an electronic control unit (ECU) that sends instruction signals to the at least one pressure regulator to pressurize each air chamber to a desired pressure.

6. The cradle of claim 5 further comprising a gas supply that provides a gas to the air chambers to pressurize the air chambers.

7. The cradle of claim 6 further comprising a valve connected to the gas supply and connected to the at least one pressure regulator, the at least one pressure regulator and the valve receiving instruction signals from the ECU to pressurize each air chamber to a desired pressure.

8. The cradle of claim 5 further comprising electrical connections that connect the ECU to the at least one pressure regulator.

9. The cradle of claim 5 wherein the ECU communicates with the at least one pressure regulator wirelessly.

10. The cradle of claim 1 wherein the at least two pressure regulators is two pressure regulators.

11. The cradle of claim 1 wherein each air chamber is a pressure regulator.

12. The cradle of claim 11 wherein each air chamber is connected to at least one microprocessor with electrical connections.

13. The cradle of claim 11 wherein the at least one microprocessor sends electrical signals to each air chamber to pressurize each air chamber to a desired pressure.

14. The cradle of claim 13 further comprising an ECU that sends signals to the at least one microprocessor, the signals containing information regarding the desired pressure for each air chamber.

15. The cradle of claim 11 further comprising an ECU that sends signals to each pressure regulator wirelessly to pressurize each air chamber to a desired pressure.
